(19) United States
(12) Patent Application Publication
(10) Pub. No.: US 2009/0080422 A1
(43) Pub. Date: Mar. 26, 2009

(54) HEADER-COMPRESSION PACKET PROCESSING METHOD, MOBILE STATION, BASE STATION, AND CONTROL STATION IN WIRELESS COMMUNICATION SYSTEM

(75) Inventors: Dong Hyun Lee, Yongin-si (KR); Bong Ho Kim, San Jose, CA (US); Su Lyun Sung, Anyang-si (KR)

Correspondence Address: BLANK ROME LLP, WATERGATE, 600 NEW HAMPSHIRE AVENUE, N.W., WASHINGTON, DC, 20037, US

(73) Assignee: POSDATA CO., LTD.

(21) Appl. No.: 12/234,189

(22) Filed: Sep. 19, 2008

Related U.S. Application Data
(60) Provisional application No. 60/994,815, filed on Sep. 21, 2007.

(30) Foreign Application Priority Data
Mar. 14, 2008 (KR) 10-2008-0023966

(51) Int. Cl. H04L 12/56

(52) U.S. Cl. 370/389

(57) ABSTRACT

A header-compression packet processing method in a wireless communication system is disclosed, which can transmit a header-compression packet through a packet transmission path mapped to a service flow, the method comprising, when a service flow of a downlink packet is mapped to a header-compression transmission channel, obtaining a second packet by adding a header-compression context ID mapped to an IP flow of the downlink packet to a first packet made by compressing a header of the downlink packet, in a control station; adding a data path tag mapped to the service flow of the downlink packet to the second packet; and transmitting the second packet with the data path tag to a base station maintaining mapping information of a connection ID for a corresponding mobile station and the data path tag, so as to transmit the second packet with the data path tag to the corresponding mobile station using the header-compression transmission channel.

This application claims the benefit of the U.S. Provisional Application Ser. No. 60/994,815 and the Korean Patent Application No. 10-2008-23966, all of which are hereby incorporated by reference for all purposes as if fully set forth herein.

### BACKGROUND OF THE INVENTION

1. Field of the Invention

The present invention relates to a header-compression processing method, a mobile station, a base station, and a control station in a wireless communication system, and more particularly, to a header-compression processing method through a packet transmission path mapped to a service flow in a broadband wireless system, a mobile station, a base station, and a control station.

2. Discussion of the Related Art

For a wireless communication system, it is especially important to improve the utilization efficiency of limited resources. Thus, it becomes more difficult to utilize an IP protocol in a wireless interface. This is because that a portion of headers occupy a large part in data to be transmitted in the IP protocol, that is, a portion for payload becomes smaller. For instance, if VoIP is implemented using IPv4, a large amount of radio frequency bandwidth is wasted on transmitting the headers. Furthermore, a header size of IPv6 is increased so that the loss of bandwidth becomes more serious.

Under inferior communication circumstances, a bit error ratio (BER) of wireless interface, and round trip time of uplink and downlink are increased largely, which may cause problems in related art header compression methods.

In this reason, there has been arisen the necessity to amend the header compression method to be appropriate for various IP protocols and packet transmissions through the wireless interface. Especially, there is the increasing demand for the efficient header compression method which can be utilized even under the inferior circumstances with the high bit error ratio and long delay. Thus, “Internet Engineering Task Force” standardizes the header compression method known as “RObust Header Compression”.

One of the most important facts to develop the ROHC is that a redundancy exists among a plurality of IP headers used for the packet transmission, as well as within the packet. That is, most information within the header is not changed during the data packet transmission. In this case, the information included in the header can be easily reconstructed in a data-receiving station even though the information is not transmitted.

With reference to “IEEE 802.16-2004 October 2004, Air Interface for Fixed and Mobile Broadband Wireless Access Systems Amendment for Physical and Medium Access Control Layers for Combined Fixed and Mobile Operation in Licensed Bands, August 2004”, “IEEE 802.16e-2005 March 2006, Physical and Medium Access Control Layers for Combined Fixed and Mobile Operation in Licensed Bands”, “RFC 3095, Robust Header Compression (ROHC): Framework and four profiles: RTP, UDP, ESP, and uncompressed, Bormann, C., July 2001”, “RFC 3759, Robust Header Compression (ROHC): Terminology and Channel Mapping Examples, L-E. Jonsson, April 2004”, and “WiMAX End-to-End Network Systems Architecture”, it is known that “WIBRO technology” and “WiMAX NWG” (WiMAX Worldwide Interoperability for Microwave Access Forum Network Working Group) are trying to provide a wireless Internet service to a mobile station through the use of header compression method such as the ROHC based on IEEE 802.16 technology standards.

However, there are unsolved problems considering structures and procedures for a ROHC function to realize ROHC function within the WiMAX network.

### SUMMARY OF THE INVENTION

Accordingly, the present invention is directed to a header-compression processing method, a mobile station, a base station, and a control station in a wireless communication system which can process a header-compression packet through a transmission path mapped to a service flow, that substantially obviate one or more problems due to limitations and disadvantages of the related art.

An object of the present invention is to provide a header-compression processing method, a mobile station, a base station, and a control station in a wireless communication system wherein an IP flow classified by a header-compression context ID is transmitted while being mapped to a service flow, a connection ID, or a data path tag.

Another object of the present invention is to provide a header-compression packet managing procedure in a control station, an ASN including a base station, and an ASN.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a header-compression packet processing method in a wireless communication system comprises, when a service flow of a downlink packet is mapped to a header-compression transmission channel, obtaining a second packet by adding a header-compression context ID mapped to an IP flow of the downlink packet to a first packet made by compressing a header of the downlink packet; adding a data path tag mapped to the service flow of the downlink packet to the second packet; and transmitting the second packet with the data path tag to a base station maintaining mapping information of a connection ID for a corresponding mobile station and the data path tag, so as to transmit the second packet with the data path tag to the corresponding mobile station using the header-compression transmission channel.

In another aspect of the present invention, a header-compression packet processing method in a wireless communication system comprises receiving a second packet with a data path tag mapped to a connection ID of an uplink packet in a control station from a base station which receives the second packet obtained by adding a header-compression context ID mapped to an IP flow of the uplink packet to a first packet made by compressing a header of the uplink packet; and, when a service flow corresponding to the data path tag of the second packet is mapped to a header-compression transmission channel including a header-compression transmission ID, reconstructing the header of the uplink packet by decompressing the second packet through the header-compression context ID.

In another aspect of the present invention, a header-compression packet processing method in a wireless communication system comprises receiving a downlink packet with a data path tag mapped to a service flow of a downlink packet in a base station from a control station; when the service flow of the downlink packet is mapped to a header-compression transmission channel, obtaining a second packet by adding a header-compression context ID mapped to an IP flow of the downlink packet to a first packet made by compressing a header of the downlink packet; and transmitting the second packet to a mobile station corresponding to a connection ID mapped to the data path tag so as to transmit the second packet to the mobile station using the header-compression transmission channel.

In another aspect of the present invention, a header-compression packet processing method in a wireless communication system comprises receiving a second packet, obtained by adding a header-compression context ID mapped to an IP flow of an uplink packet to a first packet made by compressing a header of the uplink packet, in a base station from a mobile station; when a service flow corresponding to a connection ID of the second packet is mapped to a header-compression transmission channel including the header-compression context ID, reconstructing the header of the uplink packet by decompressing the second packet through the header-compression context ID; and adding a data path tag mapped to the connection ID to the uplink packet with the reconstructed header, and transmitting it to the base station mapped to the data path tag.

In another aspect of the present invention, a header-compression packet processing method in a wireless communication system comprises performing a ROHC compression for a data packet so as to map a service flow of the data packet and a ROHC channel by 1:1 correspondence; and transmitting the ROHC-compressed data packet with a data path ID mapped to the service flow.

In another aspect of the present invention, a header-compression packet processing method in a wireless communication system comprises performing a ROHC compression for a data packet so as to map a service flow of the data packet and a ROHC channel by 1:1 correspondence; and transmitting the ROHC-compressed data packet with a connection ID mapped to the service flow.

In another aspect of the present invention, a control station in a wireless communication system comprises a header compressor configured to generate a second packet by adding a first header context ID mapped to an IP flow of a downlink packet to a first packet obtained by compressing a header of downlink packet; a header de-compressor configured to reconstruct a header of uplink packet by decompressing a second uplink packet through a second header-compression context ID when a fourth packet with the second header-compression context ID mapped to an IP flow of uplink packet is transmitted to a third packet obtained by compressing the header of uplink packet; and a data path function configured to transmit the second packet with a data path tag mapped to a service flow of the downlink packet to a base station mapped to the data path tag, and to transmit the fourth packet to the header de-compressor when a header-compression transmission channel including the second header-compression context ID is mapped to the service flow of the uplink packet.

In another aspect of the present invention, a base station in a wireless communication system comprises a header compressor configured to generate a second packet by adding a first header-compression context ID mapped to an IP flow of downlink packet to a first packet obtained by compressing a header of downlink packet; a header de-compressor configured to reconstruct a header of uplink packet by decompressing a fourth packet through a second header-compression context ID when the fourth packet with the second header-compression context ID mapped to an IP flow of uplink packet is transmitted to a third packet obtained by compressing the header of uplink packet; and a data path function configured to transmit the second packet to a mobile station according to a connection ID mapped to a data path tag added to the downlink packet and transmitted from a control station, and to transmit the fourth packet to the header de-compressor when a header-compression transmission channel including the second header-compression context ID is mapped to a service flow of the uplink packet.

In another aspect of the present invention, a mobile station in a wireless communication system comprises a header compressor configured to generate a second packet by adding a first header-compression context ID mapped to an IP flow of uplink packet to a first packet obtained by compressing a header of uplink packet; a header de-compressor configured to reconstruct a header of downlink packet by decompressing a fourth packet through a second header-compression context ID when the fourth packet with the second header-compression context ID mapped to an IP flow of downlink packet is transmitted to a third packet obtained by compressing the header of downlink packet; and a data path function configured to transmit the second packet to a base station mapped to a connection ID corresponding to a service flow of the uplink packet, and to transmit the fourth packet to the header-compressor when a header-compression transmission channel is mapped to the connection ID of the downlink packet.

Accordingly, the present invention can realize the header-compression packet processing method, the mobile station, the base station, and the control station in the wireless communication system, which can classify the IP flow by the header-compression context ID and the classifier considering whether or not the ROHC should be applied to the packet, through the use of mapping information of the header-compression context ID and the IP flow included in the service flow.

Also, the present invention can realize the header-compression packet processing method, the mobile station, the base station, and the control station in the wireless communication system, which can transmit the IP flow classified by the header-compression context ID while being mapped to the service flow, the connection ID, and the data path tag.

Also, the present invention can realize the header-compression packet processing method, the mobile station, the base station, and the control station in the wireless communication system, which can obtain the correct header-compression packet receiving/transmitting process through the classification procedure and the mapping procedure of header-compression context ID in the mobile station, base station or control station with the header compressor and header de-compressor.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a wireless communication system including a base station and a mobile station with ROHC compressor and ROHC de-compressor according to one embodiment of the present invention;

FIG. 2 is a block diagram illustrating a mapping relationship between a ROHC context ID and a service flow for ROHC packet processing in a wireless communication system according to one embodiment of the present invention;

FIGS. 3A and 3B illustrate a TLV hierarchy of service flow information included in a message between an ASN-GW and a base station, and a message between a base station and a mobile station according to one embodiment of the present invention;

FIGS. 4A and 4B are flow charts illustrating a ROHC packet processing method in a wireless communication system including a base station and a mobile station with ROHC compressor and ROHC de-compressor according to one embodiment of the present invention;

FIG. 5 is a block diagram illustrating a wireless communication system including a base station and a mobile station with ROHC compressor and ROHC de-compressor according to another embodiment of the present invention; and

FIGS. 6A and 6B are flow charts illustrating a ROHC packet processing method in a wireless communication system including a base station and a mobile station with ROHC compressor and ROHC de-compressor according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Before describing preferred embodiments of the present invention, terms to be used therein will be briefly explained as follows.

RObust Header Compression function (ROHC function): functional entity including ROHC compressor and ROHC de-compressor defined in RFC3095

ROHC service flow (ROHC SF): 802.16e service flow which is mapped to a ROHC channel, that is, a service flow in which a convergence sub-layer (CS) type is specified as “Packet, IP with ROHC header compression”

ROHC channel: logical unidirectional point to point channel for transmitting ROHC packets from the ROHC compressor to the ROHC de-compressor (see Section 2 of RFC3757)

ROHC compressor: functional entity which inspects IP headers, and compresses the IP headers into ROHC headers with ROHC header contexts (see an exemplary explanation about ROHC compressor in RFC3757)

ROHC de-compressor: functional entity which maintains header contexts, and reconstructs original headers from compressed headers (see an exemplary explanation about ROHC de-compressor in RFC3757)

Per-channel negotiation: procedure to negotiate per-channel parameters between the ROHC compressor and the ROHC de-compressor

Per-channel parameters: A ROHC channel is based on a number of parameters to form parts of established channel state and per-context state

Hereinafter, a wireless network system according to the present invention will be described with reference to the accompanying drawings.

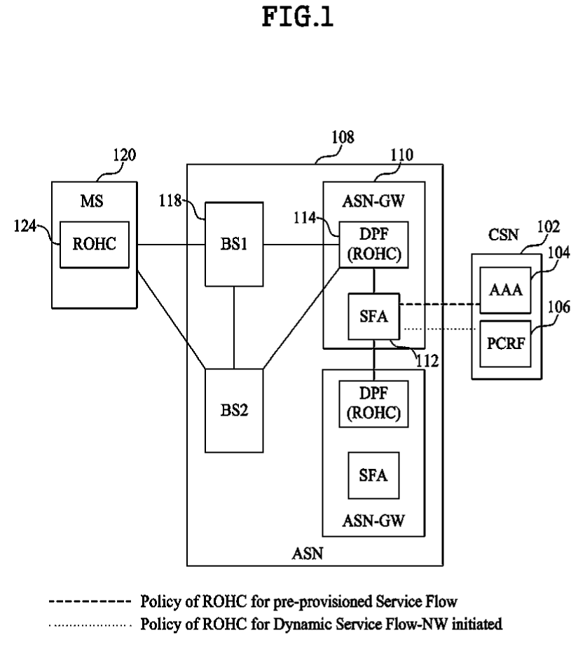

FIG. 1 is a block diagram illustrating a wireless communication system including a control station and a mobile station with a ROHC function according to one embodiment of the present invention.

Referring to FIG. 1, the wireless communication system according to one embodiment of the present invention includes a connectivity service network (hereinafter, referred to as “CSN”) 102, an access service network (hereinafter, referred to as “ASN”) 108, and a mobile station (MS) 120. In this case, ROHC downlink packets are transmitted from the CSN 102 to the mobile station 120, and ROHC uplink packets are transmitted from the mobile station 120 to the CSN 102.

The CSN 102 includes an authentication-authorization-accounting (hereinafter, referred to as “AAA”) 104, and a policy and charging rules function (hereinafter, referred to as “PCRF”) 106. The CSN 102 performs functions of user authentication, authorization and accounting management for the ASN 108 and the mobile station 120, and also creates both a billing-related rule and a network service policy for the user through the use of the PCRF 106. Also, the CSN 102 includes a home agent (HA, not shown) for supporting the mobility of mobile station 120. That is, the CSN 102 transmits the data packet from the HA (not shown) to the mobile station 120 through the ASN 108.

The AAA 104 transmits a subscriber profile including a ROHC policy during a user-authentication procedure for a pre-provisioned service flow to an access service network gateway (hereinafter, referred to as “ASN-GW”) 110, and maintains the subscriber profile including the ROHC policy. According as the aforementioned functions are performed by the AAA 104, the mobile station 102 and the ASN-GW 110 serving as a control station can recognize whether or not a ROHC should be applied.

The PCRF 106 transmits the subscriber profile including the ROHC policy to the ASN-GW 110 for a dynamic service flow, so that the mobile station 120 and the ASN-GW 110 can recognize whether or not a ROHC packet transmitting/receiving method should be applied.

The ASN 108 includes the ASN-GW 110 corresponding to the control station, and a base station 118. The ASN 108 performs a wireless interface function between the base station (BS1) 118 and the mobile station 120, a Layer-2 connection establishment function, a network discovery function, a network selection function, a transmission function for a Layer-3 connection establishment of the mobile station 120, and a radio resource management function.

The ASN-GW 110 includes a service flow authorization (hereinafter, referred to as “SFA”) 112 serving as the control station, a data path function (hereinafter, referred to as “DPF”) 114, and a ROHC function (not shown). The ASN-GW 110 compresses downlink packets by ROHC, and transmits them to the base station 118. Also, the ASN-GW 110 decompresses ROHC uplink packets by ROHC, and transmits them to the CSN 102. At this time, the ROHC function is arranged together with the DPF 114, wherein the ROHC function includes a ROHC compressor (not shown) and a ROHC de-compressor (not shown).

The SFA 112 receives the ROHC policy from the AAA 104 or the PCRF 106. The SFA 112 generates and distributes a classification rule for ROHC. Also, the SFA 112 exchanges information of the service flow with the ROHC function 124 in the mobile station 120 through a service flow management (not shown, hereinafter referred to as “SFM”) of the base station 118. If the mobile station 120 accepts the service flow containing the ROHC classification, the SFA 112 triggers a ROHC per-channel parameter negotiation after a service flow negotiation procedure. The SFA 112 generates service flow information of the service flow for the ROHC packet transmitting-receiving method, so that the ASN-GW 110, the base station 118, and the mobile station 120 can obtain the service flow information.

A data path ID corresponding to a sub-TLV (Type Length Value) of the service flow information includes a data path tag such as a generic routing encapsulation key (hereinafter, referred to as “GRE key”) mapped to the service flow. Also, the service flow information includes a ROHC parameter obtained through the information exchange between the ROHC compressor and ROHC de-compressor in the ASN-GW 110. In this case, the ROHC parameter may include a ROHC per-channel parameter, a ROHC per-context parameter, a profile, a context, a ROHC context ID, and a classifier related to whether or not the ROHC is applied.

Accordingly, before receiving the ROHC packet, the ASN-GW 110 and the mobile station 120 can obtain the ROHC parameter including the ROHC context ID mapped to the service flow, and the information concerning whether or not the ROHC packet of the service flow for ROHC packet is received, through the service flow information.

The ROHC function in the ASN-GW 110 initiates the per-channel parameter negotiation with the ROHC function 124 in the mobile station 120. The per-channel parameter negotiation is performed through the negotiation of per-channel parameters between the ROHC compressor and the ROHC de-compressor in the ASN-GW 110 and the mobile station 120. Since the ROHC channel is one-to-one mapped to the service flow, the per-channel parameters are included in the service flow information, and a dynamic service addition message DSA-REQ/DSA-RSP including the service flow information is used for the per-channel parameter negotiation. The ROHC compressor in the ASN-GW 110 compresses IP headers into ROHC packet headers maintaining ROHC contexts. The ROHC de-compressor maintains header contexts, and reconstructs original headers from compressed headers with the header contexts.

The DPF 114 performs a classification for downlink (DL) packet, and checks whether or not it requires the ROHC compression. If the DL packets belong to the ROHC channel, the DPF 114 transmits the DL packets to the ROHC compressor. Then, the DPF 114 performs an encapsulation of R6 (data path between the base station and the mobile station) data path tag, and transmits it to the base station (BS1) 118. The DPF 114 receives uplink (UL) packets from the base station 118. If the received UL packets belong to the ROHC channel, the DPF 114 transmits the UL packets to the ROHC de-compressor.

The base station 118 maintains a mapping relationship between the R6 data path tag and a connection ID (802.16e CID). The base station 118 processes the DL packets by replacing R6 GRE key corresponding to the R6 data path tag with the 802.16e CID, and processes the UL packets by replacing the 802.16e CID with the R6 GRE key.

The mobile station 120 establishes a channel between the ROHC function 124 and a CS layer when a DSA message contains an ROHC type. If the DL packets belong to the ROHC channel, the DL packets are transmitted to the ROHC de-compressor in the ROHC function 124.

For UL traffic, the mobile station 120 performs a classification to identify whether or not the data packets require the ROHC compression. If the UL packet belongs to the ROHC channel, the mobile station 120 performs the ROHC compression. Then, the mobile station 120 transmits the UL packet to the base station 118 through the use of the appropriate 802.16e CID mapped to the ROHC channel of the UL packet.

Hereinafter, the mapping relationship of the ROHC context ID and the service flow for the ROHC packet transmitting/receiving method will be explained as follows.

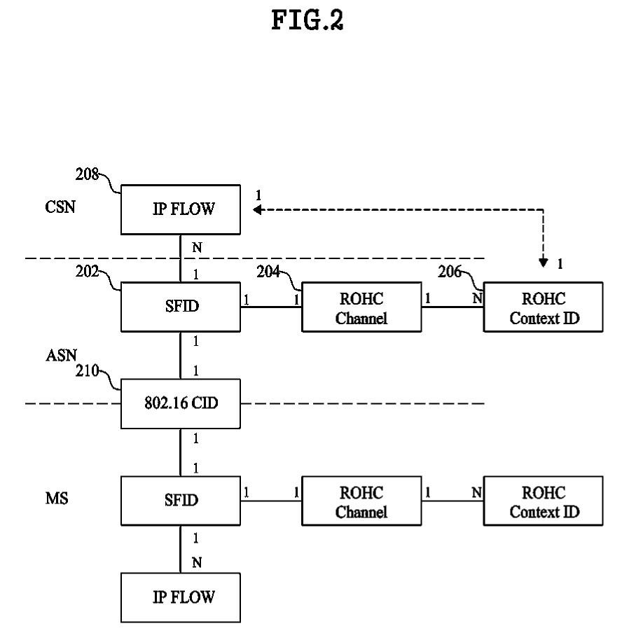

FIG. 2 illustrates the mapping relationship of the ROHC context ID and the service flow for the ROHC packet transmitting/receiving method in the wireless communication system according to one embodiment of the present invention. Herein, the mapping relationship between the service flow and the ROHC channel is 1:1. One ROHC channel may have an IP flow using the plurality of ROHC. In this case, the ROHC channel means a header-compression transmission channel applied by ROHC.

According to one example of the downlink packet which can have the IP flow 208 of ‘N’ types transmitted from the CSN 102, the mapping relationship between the IP flow 208 and the service flow ID (hereinafter, referred to as “SFID”) 202 is N:1 (‘N’ is a positive integer), and the mapping relationship between the ROHC context ID 206 and the IP flow 208 is 1:1.

The mapping relationship between the ROHC channel corresponding to a logic channel and the SFID 202 in the ASN 108 is 1:1. At this time, the mapping relationship between the ROHC channel 204 and the ROHC context ID 206 is 1:N (‘N’ is a positive integer). Accordingly, the mapping relationship between the SFID 202 and the ROHC context ID 206 through the ROHC channel 204 is 1:N (‘N’ is a positive integer).

Since the SFID 202 is mapped to the connection ID 210 between the base station 118 and the mobile station 120 by 1:1 correspondence, the mapping relationship between the connection ID 210 and the ROHC context ID 206 is also 1:N. In this case, the aforementioned mapping relationships are identically applied in the ASN 108 and the mobile station 120.

The aforementioned mapping relationships are recognized in the ASN 108 and the mobile station 120 when creating the service flow for ROHC. Through the mapping relationships, the ASN-GW 118 and the mobile station 120 can identify whether or not the ROHC should be applied. That is, the ASN-GW, base station or mobile station to be received with the ROHC packet can be identified through the mapping relationships. The base station 118 and the mobile station 120 can obtain the service flow information through the mapping relationship.

The service flow information may include a packet classification rule, an ROHC/ECRTP (Enhanced Compressed RTP) context ID, a classifier type, or a convergence sub-layer parameter encoding rule (CS parameter encoding rule) as sub-TLV. Whether or not the ROHC should be applied is defined by the CS parameter encoding rule. The ROHC context ID 206 is defined by the ROHC/ECRTP context ID. Accordingly, the ASN-GW 110 and the mobile station 120 can identify whether or not the ROHC is applied to the corresponding service flow by checking the service flow information, and can obtain the ROHC context ID 206 mapped to the IP flow included in the corresponding service flow.

Also, the base station 118 obtains the mapping information between the connection ID 210 and the data path ID (GRE key) corresponding to the service flow through the use of service flow information.

The mobile station 120 obtains the mapping information between the ROHC channel 204 including the ROHC context ID 206 and the connection ID 210 between the mobile station 120 and the base station corresponding to the service flow through the use of service flow information.

Through the aforementioned mapping information, the ASN-GW 110 can identify whether or not the received DL packet should be applied by ROHC, and can identify the base station 118 to be received with the ROHC packet after performing the ROHC compression. The base station 118 can identify the mobile station to be received with the ROHC packet. The mobile station 120 can identify whether or not the ROHC should be applied to the ROHC packet, and can perform the ROHC de-compression. In a case of the UL packet, the aforementioned steps are performed in reverse order.

Referring to FIG. 1, the service flow information including the ROHC parameter such as the ROHC context ID and the information about whether or not the ROHC should be applied is created by the SFA 112, and is included in a data path registration request message Path_Reg_Req. The data Path_Reg_Req including the service flow information is transmitted from the ASN-GW 110 to the base station 118.

Then, the service flow information included in a dynamic service addition message DSA_REQ may be transmitted from the base station 118 to the mobile station 120. In this case, since the Path_Reg_Req message and the DSA_REQ message can include the service flow information as TLV, the ROHC parameter included in the service flow information can be transmitted through the Path_Reg_Req message and the DSA_REQ message.

Also, the service flow information including the predetermined ROHC parameter is transmitted from the mobile station 120 to the ASN-GW 110 through the Path_Reg_Rsp message and the DSA-RSP message. That is, the ASN-GW 110 and the mobile station 120 can perform ROHC negotiation by exchanging the ROHC parameter through the service flow information included in the Path_Reg_Req/Rsp message and DSA_REQ/RSP message.

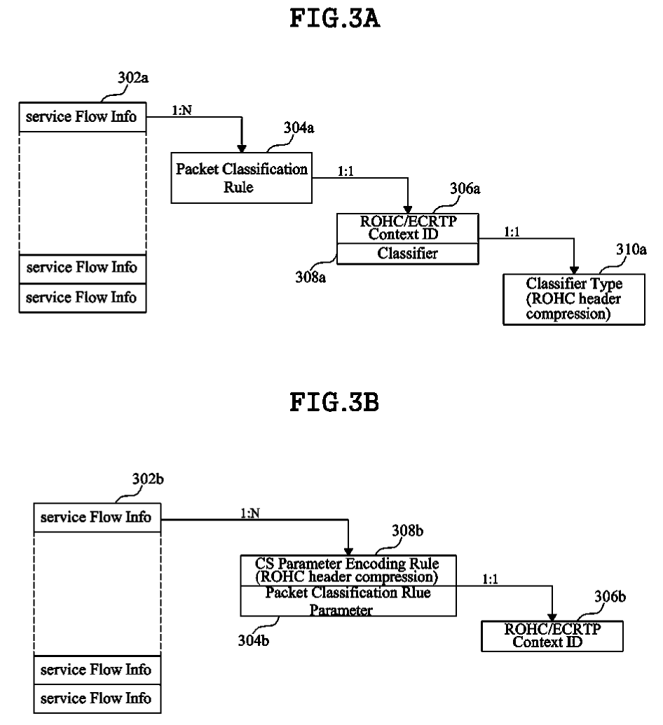

Hereinafter, TLV hierarchy of the service flow information, transmitted by the Path_REg_Req/Rsp message and DSA-REQ/RSP message, including the ROHC context ID and the information about whether or not the ROHC should be applied will be explained with reference to FIGS. 3A and 3B.

FIG. 3A illustrates the TLV hierarchy of the service flow information included in the message between the ASN-GW and the base station in the wireless communication system according to one embodiment of the present invention.

The message between the ASN-GW and the base station, the Path_Reg_Req/Rsp message may include service flow information 302a as TLV, wherein the service flow information 302a may include a packet classification rule 304a as sub-TLV. The packet classification rule 304a may include an ROHC/ECRTP context ID 306a and a classifier 308a as sub-TLV, and the classifier 308a may include a classifier type 310a as sub-TLV.

Referring to FIG. 3A, whether or not the ROHC should be applied may be defined by the classifier type 310a. The ROHC context ID mapped to the service flow for the ROHC packet transmitting/receiving method may be defined by the ROHC/ECRTP context ID 306a.

FIG. 3B illustrates the TLV hierarchy of the service flow information included in the message between the base station and the mobile station in the wireless communication system according to one embodiment of the present invention.

The message between the base station and the mobile station, the DSA-REQ/RSP message may include service flow information 302b as TLV, wherein the service flow information 302b may include a packet classification rule parameter 304b and a CS parameter encoding rule 308b as sub-TLV. Also, the packet classification rule parameter 304b may include an ROHC/ECRTP context ID 306b as sub-TLV.

Referring to FIG. 3B, whether or not ROHC should be applied may be defined by the CS parameter encoding rule 308b of the TLV. The ROHC context ID mapped to the service flow for the ROHC packet transmission may be defined by the ROHC/ECRTP context ID 306b.

The aforementioned service flow information 302b may include the sub-TLV (not shown) including the other ROHC parameter as well as the ROHC context ID and the information considering whether or not the ROHC should be applied. Through the service flow information 302b including the aforementioned TLV hierarchy transmitted by the Path_Reg_Req message and the DSA-REQ/RSP message, the ASN-GW 110 and the mobile station 120 can previously recognize the ROHC parameter to identify the ROHC context ID 110 and whether or not the corresponding service flow should be applied by ROHC, before the ROHC packet transmission.

Referring to FIG. 1, when the DPF 114 receives the downlink packet from the CSN 102, the DPF 114 classifies the downlink packet by determining whether or not the ROHC should be applied. If the service flow of the downlink packet uses the ROHC packet transmitting/receiving method, the mapping information between the ROHC channel and the SFID is previously stored in the DPF 114. Accordingly, whether or not the ROHC should be applied to the downlink packet can be determined by the mapping information between the ROHC channel and the SFID.

In one embodiment of the present invention, when the mapping relationship between the ROHC context ID and the ROHC channel is N:1, the DPF 114 can determine whether or not the corresponding downlink packet requires the ROHC through the mapping information between the ROHC channel ID and the SFID.

In one embodiment of the present invention, the mapping information is created when creating the service flow for ROHC. Also, entities 110, 118, 120 of the wireless communication system using the ROHC can generate and maintain the mapping information of the ROHC channel from the information obtained through the use of service flow information (SF-Info) received and transmitted for the service flow creation procedure.

In the modified embodiment of the present invention, whether or not the downlink packet should be applied by the ROHC can be determined by the packet classification rule of sub-TLV included in the service flow information of the downlink packet.

In one embodiment of the present invention, when it is determined that the downlink packet uses the ROHC channel, the DPF 114 transmits the downlink packet to the ROHC compressor in the ROHC function.

Also, when the ROHC downlink packet with the ROHC context ID mapped to the IP flow of the downlink packet, which is obtained by compressing the downlink packet in the ROHC de-compressor in the ROHC function, is transmitted to the DPF 114, the DPF 114 performs an encapsulation procedure for adding the data path tag mapped to the service flow of the downlink packet to the ROHC downlink packet, and then transmits it to the base station 118 mapped to the data path tag.

The mapping relationship between the data path tag and the service flow is 1:1. Accordingly, if there are ‘N’ ROHC context IDs, the mapping relationship between the data path tag and the ROHC context ID becomes 1:N. In this case, the mapping information of the data path tag and the service flow corresponds to the information which is previously recognized by the ASN-GW 110 for the ROHC packet transmission.

In one embodiment of the present invention, the data path tag may be a data path ID included in the service flow information of the service flow for the ROHC packet transmission. The data path ID may be the GRE key.

In one embodiment of the present invention, when the corresponding downlink packet is classified as one which doesn't require the ROHC de-compression, the DPF 114 may transmit the downlink packet to the base station 118 instead of the ROHC compressor.

The data path tag is added to the ROHC downlink packet, and the ROHC downlink packet with the data path tag added thereto is transmitted to the base station 118 through a tunnel between the ASN-GW 110 and the base station 118.

Also, when the DPF 114 receives the ROHC uplink packet from the base station 118, the DPF 114 classifies the ROHC uplink packet by determining whether or not the ROHC should be applied.

The DPF 114 checks the service flow mapped to the data path tag added to the ROHC uplink packet, and checks the mapping information to identify whether or not the ROHC channel mapped to the service flow exists. Then, when the corresponding ROHC channel exists, the ROHC uplink packet is de-capsulated, and is transmitted to the ROHC de-compressor.

The data path tag, added to the uplink packet and transmitted together with the uplink packet, is mapped to the service flow of the ROHC uplink packet by 1:1 correspondence. If there are the ROHC context IDs of ‘N’ types, the mapping relationship between the data path tag and the ROHC context ID is 1:N. Also, the mapping information is previously stored in the DPF 114. Also, the DPF 114 can transmit the uplink packet whose header is reconstructed to the original state, received from the ROHC de-compressor, to the CSN 102.

The ROHC compressor compresses the downlink packet classified and transmitted from the DPF 114, generates the ROHC downlink packet with the ROHC context ID mapped to the IP flow of the downlink packet, and transmits the generated ROHC downlink packet to the DPF 114.

In the ROHC compressor, there are the ROHC parameter corresponding to the IP flow, and the mapping information between the IP flow of the downlink packet and the ROHC context ID. Then, the ROHC compressor transmits a service flow creation request for the ROHC transmission to the SFA 112, so that the ROHC parameter included in the service flow information is transmitted to the mobile station 120.

The ROHC de-compressor reconstructs the header of the ROHC uplink packet, classified and transmitted from the DPF 114, through the use of the pre-stored ROHC context ID, and then transmits it to the DPF 114. At this time, the ROHC de-compressor obtains and stores the context corresponding to the ROHC context ID through the service flow information of the uplink packet. Also, the ROHC de-compressor reconstructs the header of the ROHC uplink packet through the context.

Upon receiving the ROHC downlink packet with the data path tag added thereto, the base station 118 performs the de-capsulation procedure, and transmits the ROHC downlink packet to the mobile station 120 corresponding to the connection ID (CID) mapped to the data path tag. If the service flow uses the ROHC packet transmission, the data path tag mapped to the service flow is transmitted to the base station 118 through the service flow information. Also, the mapping relationship between the data path tag and the connection ID (CID) is 1:1, and this mapping information is maintained in the base station 118. Accordingly, the base station 118 can find the connection ID (CID) mapped to the data path tag through the use of the mapping information.

Upon receiving the ROHC uplink packet, the base station 118 performs the encapsulation procedure for adding the data path tag mapped to the service flow of the ROHC uplink packet, and transmits it to the ASN-GW 110 mapped to the data path tag.

The mobile station 120 includes a ROHC function 124 and a DPF (not shown). The ROHC function 124 in the mobile station 120 includes a ROHC compressor (not shown) and a ROHC de-compressor (not shown). The mobile station 120 establishes a channel between the ROHC function entity and CS layer when a CSA message contains a ROHC type. If the received DL packets belong to the ROHC channel, the mobile station 120 transmits the DL packets to the ROHC de-compressor in the ROHC function 124. Also, the mobile station 120 performs the classification procedure to identify whether or not the packets require the ROHC compression. In order to transmit the packets, the mobile station 120 maps the ROHC channel to the appropriate connection ID (802.16e CID).

In the explanation considering the mobile station 120 of FIG. 1, the mobile station 120 includes the DPF, the ROHC compressor and the ROHC de-compressor.

Upon receiving the ROHC downlink packet from the base station 118, the DPF in the mobile station 120 determines whether or not the ROHC should be applied, and classifies the ROHC downlink packet.

The mapping relationship between the connection ID (CID) mapped to the service flow of the ROHC downlink packet and the ROHC channel including the ROHC connection ID is 1:1, and this mapping information is maintained in the mobile station 120. Accordingly, the DPF can recognize whether or not the ROHC downlink packet should be applied by ROHC through the use of the mapping information.

If the ROHC channel ID mapped to the connection ID (CID) of the ROHC downlink packet exits in the mapping information, the DPF classifies the corresponding packet as one which requires the ROHC, and transmits the corresponding packet to the ROHC de-compressor. For the IP classification, the DPF transmits the downlink packet whose header is reconstructed by the ROHC de-compressor to the upper layer, IP layer.

Upon receiving the uplink packet from the upper layer, IP layer, the DPF performs the classification procedure to determine whether or not the uplink packet should be applied by ROHC, before transmitting the uplink packet to a media access control (MAC) layer.

When the ROHC channel is mapped to the service flow of the uplink packet through the mapping information maintained in the DPF, the DPF determines that the ROHC packet transmission is used. In the modified embodiment of the present invention, whether or not the ROHC should be applied can be determined based on the CS parameter encoding rule, sub-TLV of the service flow information of the uplink packet. When it is determined that the uplink packet should be applied by ROHC, the DPF transmits the uplink packet to the ROHC compressor. Also, when the DPF receives the ROHC uplink packet from the ROHC compressor, the DPF transmits the ROHC uplink packet to the base station 118 corresponding to the connection ID (CID) for the service flow of the uplink packet.

The mapping relationship between the service flow of the ROHC uplink packet and the connection ID (CID) is 1:1, and this mapping information is maintained in the mobile station 120. Accordingly, the DPF can find the connection ID (CID) of the ROHC uplink packet through the use of the mapping information.

The ROHC compressor compresses the uplink packet classified and transmitted from the DPF, generates the ROHC uplink packet with the ROHC context ID mapped to the IP flow of the uplink packet, and transmits the generated ROHC uplink packet to the DPF. The ROHC de-compressor reconstructs the header of the ROHC downlink packet, classified and transmitted from the DPF, through the use of the pre-stored ROHC context ID, and then transmits it to the DPF. At this time, since the context corresponding to the ROHC context ID is previously stored in the ROHC de-compressor, the ROHC de-compressor can reconstruct the header through the context. The ROHC de-compressor obtains and maintains the ROHC context ID through the service flow information of the downlink packet, and performs the ROHC de-compression through the use of ROHC context ID.

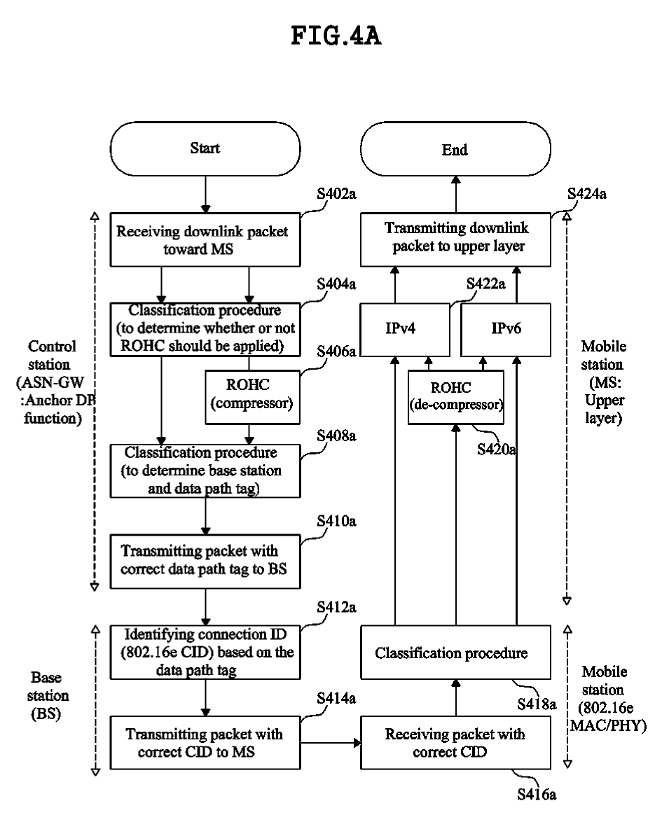

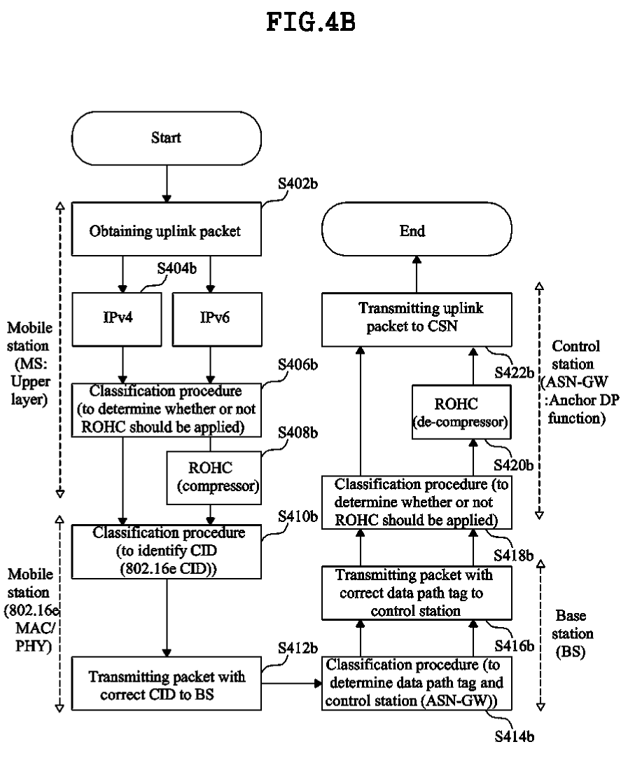

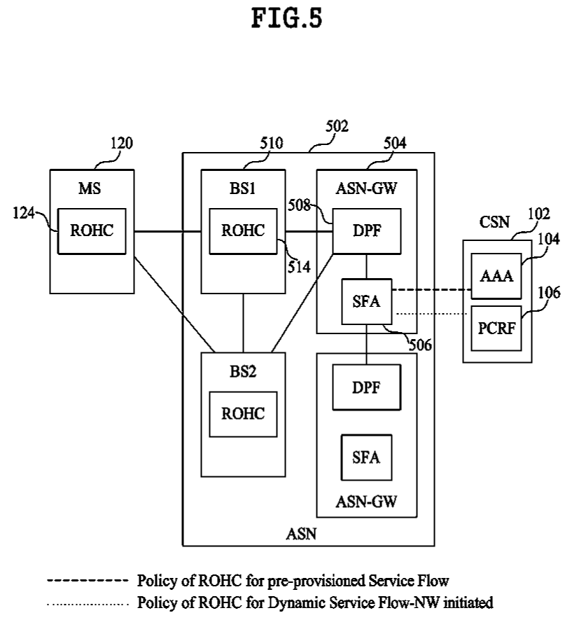

FIGS. 4A and 4B are block diagrams illustrating the ROHC packet processing method in the wireless communication system including the mobile station and the control station with the ROHC compressor and the ROHC de-compressor according to one embodiment of the present invention.

FIG. 4A illustrates the ROHC downlink packet processing method when the control station and the mobile station include the ROHC compressor and the ROHC de-compressor.

First, when an anchor data path function (hereinafter, referred to as “anchor DP function”) in the ASN-GW corresponding to the control station receives the downlink packet toward the mobile station from the CSN (S402a), the classification procedure is performed to determine whether or not the downlink packet should be applied by ROHC, based on the packet classification rule (S404a).

In one embodiment of the present invention, if the ROHC channel ID mapped to the SFID of the downlink packet exists in the mapping information of the SFID and the ROHC channel ID containing the ROHC context ID, the ASN-GW can classify the corresponding downlink packet as one requiring the ROHC. At this time, the mapping information is maintained in the ASN-GW.

If it is determined that the corresponding downlink packet should be applied by ROHC, the ASN-GW transmits the corresponding downlink packet to the ROHC compressor. Meanwhile, if it is determined that the corresponding downlink packet doesn't require the ROHC, the ROHC compression is not performed in the corresponding downlink packet.

The downlink packet classified as one requiring ROHC is firstly compressed, and then the ROHC context ID mapped to the IP flow of the downlink packet is added to the compressed downlink packet, to thereby generate the ROHC downlink packet (S406a). At this time, the ROHC context ID corresponds to the information maintained in the ROHC compressor.

The ASN-GW classifies the ROHC downlink packet by the mapping table of the SFID and the ROHC channel ID, and determines the data path tag mapped to the service flow, and the base station to be provided with the ROHC downlink packet (S408a). At this time, the base station is mapped to the data path tag, and the data path tab may be the GRE Key. Since a tunnel, serving the data path tag as the Key, is generated between the ASN-GW and the base station, the base station is determined according to the selection of data path tag.

Next, the ASN-GW adds the data path tag to the ROHC downlink packet, and transmits it to the base station through R6 (between base station and ASN-GW)/R4 (between ASN-GW and ASN-GW) data path (S410a). The base station performs the de-capsulation for the ROHC downlink packet, and classifies the connection ID (CID) based on the data path tag (S412a). The base station obtains the mapping information of the connection ID (CID) and the data path tag mapped to the service flow of the ROHC downlink packet through the service flow information. Accordingly, when the base station receives the ROHC downlink packet, the base station can find the correct connection ID (CID) mapped to the data path tag through the use of mapping information.

Next, the ROHC downlink packet with the correct connection ID (CID) is transmitted toward the mobile station (MS) (S414a). At this time, the mobile station corresponds to the connection ID (CID). Then, when the mobile station receives the ROHC downlink packet (S416a), the mobile station performs the classification procedure to determine whether or not the ROHC downlink packet should be applied by ROHC (S418a).

If it is determined that the ROHC channel ID exists through the use of maintained mapping information of the ROHC channel ID and the connection ID (CID), the mobile station can classify the ROHC downlink packet as one requiring ROHC. Then, the header of the ROHC downlink packet, classified as one requiring ROHC, is reconstructed by the ROHC de-compression through the ROHC context ID maintained in the ROHC de-compressor (S420a). At this time, the procedure of determining whether or not the ROHC should be applied (S418a) may be performed in the CS layer of IEEE 802.16e for the ROHC downlink packet transmitted from MAC/PHY layer, or the ROHC de-compression procedure (S420a) may be performed in the IP or ROHC layer being in contact through the CS and service access point (hereinafter, referred to as “SAP”).

Next, the IP version of the downlink packet whose header is reconstructed may be classified, or the IP version of the downlink packet whose header is not reconstructed may be classified (S422a). Then, the classified downlink packet is transmitted to the upper layer (S424a).

FIG. 4B illustrates the ROHC uplink packet processing method when the control station and the mobile station include the ROHC compressor and the ROHC de-compressor.

First, when the mobile station obtains the uplink packet (S402b), the mobile station transmits the uplink packet from the upper layer to the IP layer, classifies the IP version of the uplink packet (S404b), and performs the classification procedure to determine whether or not the uplink packet should be applied by ROHC (S406b). This is to determine whether or not the uplink packet passes through the ROHC entity before transmitting the uplink packet to the MAC layer. At this time, the classification rule can be implemented in a shim layer between the IP layer and the ROHC layer, or within the ROHC layer.

The mobile station can determine whether or not the ROHC should be applied through the use of mapping information of the ROHC channel and the service flow of the uplink packet obtained through the service flow creation procedure. Then, the ROHC compressor of the mobile station compresses the uplink packet classified as one requiring the ROHC, and generates the ROHC uplink packet with the ROHC context ID mapped to the IP flow of the uplink packet (S408b). At this time, the IP flow, the service flow, and the ROHC channel are mapped in relation of N:1:1.

Then, a classification procedure for classifying the correct connection ID (CID) is performed to transmit the ROHC uplink packet (S410b). According as the connection ID (CID) is determined through the use of mapping table of the ROHC channel and the connection ID (802.16e CID) in the CS for the ROHC-compressed packet, the classification procedure is performed again. At this time, since the mapping relationship between the connection ID (CID) and the service flow of the ROHC uplink packet is 1:1, the corresponding connection ID (CID) can be identified through the SFID. If it is determined that it doesn't require the ROHC, the classification procedure for the connection ID (S410b) is performed without the compression procedure (S408b).

Then, the ROHC uplink packet with the correct connection ID (CID) is transmitted toward the base station (S412b). At this time, the base station corresponds to the connection ID (CID). Then, the base station performs the classification procedure for determining the ASN-GW and the correct data path tag for the ROHC uplink packet received (S414b). In one embodiment of the present invention, the DPF in the base station receives the data packet from the mobile station, and performs the classification procedure (S414b).

The data path tag is transmitted to the base station through the service flow information. According as the mapping relationship between the data path tag and the service flow of the ROHC uplink packet is 1:1, the mapping relationship between the data path tag and the connection ID (CID) is 1:1. The base station can find the data path tag through the use of the data path tag maintained therein and the mapping information of the connection ID (CID). Also, since a tunnel, serving the data path tag as a key, is generated between the base station and the ASN-GW, the ASN-GW is determined according to the selection of data path tag.

Then, the base station transmits the ROHC uplink packet with the data path tag to the ASN-GW (S416b). That is, the base station transmits the compressed-packet with the data path tag based on 802.16e CID to the ASN-GW. Then, the control station, ASN-GW performs the classification procedure to determine whether or not the ROHC uplink packet should be applied by ROHC (S418b).

If the SFID of the compressed-packet is mapped to the ROHC channel, the data packet is transmitted to the ROHC entity for the de-compression. Then, the ROHC de-compressor reconstructs the header of the uplink packet by de-compressing the ROHC uplink packet through the ROHC context ID (S420b). The uplink packet which is ROHC-decompressed is transmitted to the CSN (S422b).

FIG. 5 illustrates a wireless communication system including a mobile station and a base station with ROHC compressor and ROHC de-compressor according to another embodiment of the present invention.

Referring to FIG. 5, the wireless communication system according to another embodiment of the present invention includes a CSN 102, an ASN 502, and a mobile station (MS) 120. In this case, ROHC downlink packets are transmitted from the CSN 102 to the mobile station 120, and ROHC uplink packets are transmitted from the mobile station 120 to the CSN 102.

Hereinafter, the explanation for some parts of FIG. 5, which are identical in function to those of FIG. 1, will be omitted.

The ASN 502 includes an ASN-GW 504 serving as a control station, and a base station (BS1) 510 performing ROHC compression of downlink packets and ROHC de-compression of uplink packets. At this time, the ASN-GW 504 includes an SFA 506 and a DPF 508. The SFA 506 generates service flow information of service flow for transmission of ROHC packets, so that the ASN-GW 504, the base station 510 and the mobile station 120 can obtain the service flow information.

A data path ID, sub-TLV of the service flow information includes a data path tag such as a GRE key mapped to the service flow. Also, the service flow information includes a ROHC parameter obtained through an information exchange between ROHC compressor and ROHC de-compressor in a ROHC function 514 of the base station 510. At this time, the ROHC parameter may include a ROHC per-channel parameter, a ROHC per-context parameter, a profile, a context, a ROHC context ID, and a classifier related with whether or not a ROHC should be applied. Accordingly, the base station 510 and the mobile station 120 can obtain the ROHC parameter by performing the ROHC negotiation through the service flow information, before receiving the ROHC packet.

During a service flow creation procedure for the transmission of ROHC packet, the service flow information with the ROHC parameter, included in a Path_Reg_Req/Rsp message, can be transmitted between the ASN-GW 504 and the base station 510, and the service flow information with the ROHC parameter, included in a DSA-REQ message, can be transmitted between the base station 510 and the mobile station 120. At this time, the Path_Reg_Req/Rsp message and DSA-REQ/RSP message may include the service flow information as TLV so that it enables the transmission of ROHC parameter.

Whether or not the ROHC should be applied and the ROHC context ID may be included in the Path_Reg_Req/Rsp message and DSA-REQ/RSP message through the service flow information including TLV hierarchy shown in FIGS. 3A and 3B.

The DPF 508 of the ASN-GW 504 performs an encapsulation procedure to add the data path tag mapped to the service flow of the downlink packet to the downlink packet transmitted from the CSN, and transmits it to the base station 510 mapped to the data path tag. At this time, the data path tag mapped to the service flow is pre-stored in the ASN-GW 504. Since a tunnel serving the data path tag as a key is generated between the ASN-GW 504 and the base station 510, the base station 510 is determined according to the selection of data path tag.

When the uplink packet is transmitted from the base station 510 to the DPF 508, the DPF 508 performs the de-capsulation for the uplink packet, and transmits it to the CSN 102.

The base station 510 includes a ROHC function 514 and a DPF (not shown). The base station 510 compresses the downlink packet by ROHC, and transmits it to the mobile station 120. Also, the base station 510 de-compresses the ROHC uplink packet by ROHC, and transmits it to the ASN-GW 504. At this time, the ROHC function 514 is arranged together with the DPF, wherein the ROHC function 514 includes a ROHC compressor (not shown) and a ROHC de-compressor (not shown).

The base station 510 transmits the service flow information with the ROHC parameter to the mobile station 120 so that the ROHC context ID is stored in the mobile station 120 and the ROHC negotiation is performed. In the explanation considering the base station 510 of FIG. 5, the base station 510 includes the DPF, the ROHC compressor and the ROHC de-compressor.

When the downlink packet with the data path tag added thereto is transmitted to the DPF, the DPF of the base station 510 performs the de-capsulation procedure, and performs the classification procedure to determine whether or not the ROHC should be applied.

The mapping relationship between the corresponding service flow and the data path tag added to the downlink packet is 1:1, and the mapping relationship between the service flow and the ROHC channel is 1:1. Accordingly, it is possible to determine whether or not the downlink packet should be applied by ROHC through the use of mapping information of the service flow and the ROHC channel maintained in the DPF.

If it is determined that the downlink packet should be applied by ROHC, the DPF transmits the downlink packet to the ROHC compressor. When the DPF receives the ROHC downlink packet from the ROHC compressor, the DPF transmits the ROHC downlink packet to the mobile station 120 corresponding to the connection ID (CID) mapped to the data path tag. The DPF can maintain the mapping information of the connection ID (CID) and the data path tag, and find the connection ID (CID) through the use of mapping information.

If the ROHC uplink packet is transmitted from the mobile station 120 to the DPF, the DPF determines whether or not the ROHC should be applied for classification of the ROHC uplink packet. If there is the ROHC channel mapped to the service flow corresponding to the connection ID (CID) of the ROHC uplink packet, the corresponding ROHC uplink packet is classified as one which requires ROHC, and is then transmitted to the ROHC de-compressor. At this time, the mapping information of the service flow and the ROHC channel is maintained in the base station.

When the DPF receives the uplink packet from the ROHC de-compressor, the DPF performs the encapsulation procedure for adding the data path tag mapped to the connection ID (CID) of the uplink packet to the uplink packet, and transmits it to the ASN-GW 504 mapped to the data path tag. At this time, the mapping information of the data path tag and the connection ID (CID) corresponds to the information maintained in the DPF, and the corresponding data path tag can be found through the use of the mapping information. Also, since the tunnel serving as the data path tag as the key is generated between the ASN-GW 504 and the base station 510, the ASN-GW 504 is determined according to the selection of the data path tag.

The ROHC compressor generates the ROHC downlink packet by compressing the downlink packet, and transmits the generated ROHC downlink packet to the DPF. The ROHC de-compressor reconstructs the header of the ROHC uplink packet through the ROHC context ID, and transmits it to the DPF.

The method for processing the ROHC downlink packet and ROHC uplink packet in the mobile station 120 is identical to that of FIG. 1, the explanation of which will be omitted.

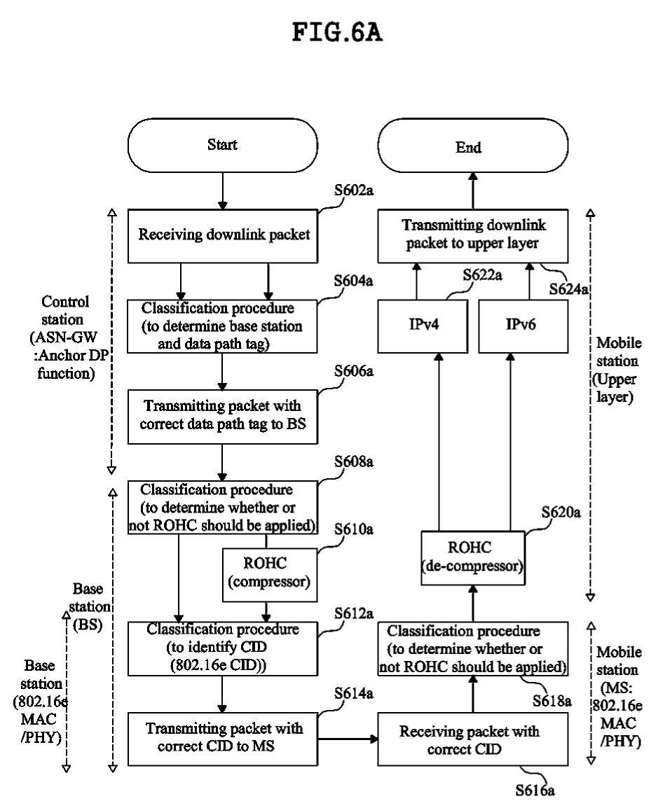

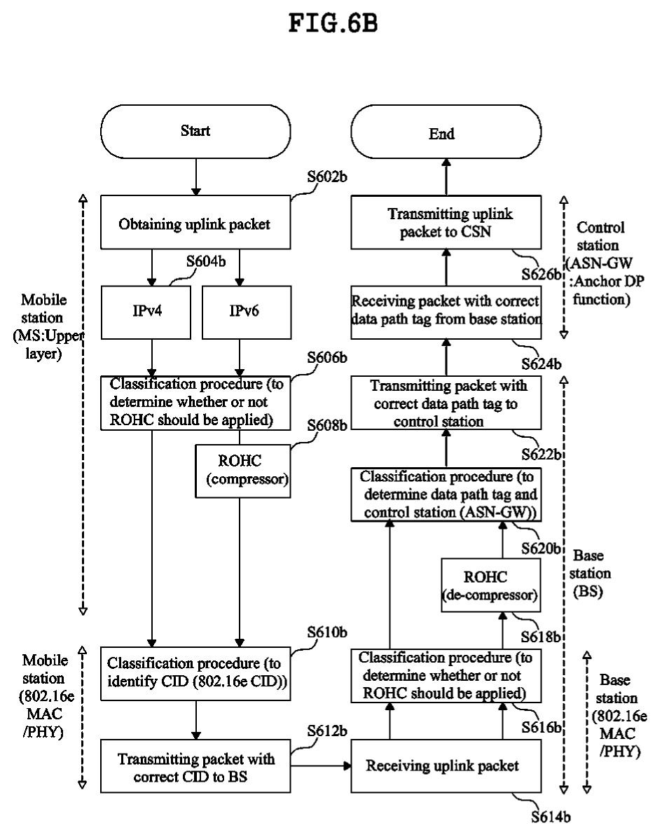

FIGS. 6A and 6B are flow charts illustrating the ROHC packet processing method in the wireless communication system including the mobile station and the base station with ROHC compressor and ROHC de-compressor according to another embodiment of the present invention. The detailed ROHC packet processing method, which is not explained in each step of FIG. 6A and FIG. 6B, can be described with reference to those of FIG. 4A and FIG. 4B.

FIG. 6A illustrates the ROHC downlink packet processing method when the base station and the mobile station include ROHC compressor and ROHC de-compressor.

First, when an anchor DP function in the ASN-GW serving as the control station receives the downlink packet from the CSN (S602a), the classification procedure is performed to determine the data path tag for the downlink packet, and the base station to be received with the downlink packet (S604a).

Then, the ASN-GW transmits the downlink packet with the data path tag to the determined base station. That is, the anchor DP function of the ASN-GW transmits the data packet with the data path tag such as the GRE key to the base station through R6/R4 data path.

The base station classifies the IP flow according to the packet classification rule, to thereby determine whether or not the downlink packet should be applied by ROHC (S608a). Based on the packet classification rule, the base station determines whether or not the corresponding service flow should be applied by ROHC entity.

The ROHC compressor of the base station compresses the downlink packet, classified as one which requires the ROHC, and generates the ROHC downlink packet with the ROHC context ID mapped to the IP flow of the downlink packet (S610a).

The base station performs the classification procedure to determine the connection ID (CID) mapped to the data path tag (S612a). At this time, the base station performs the classification procedure for identifying the connection ID (CID) by the mapping table of the ROHC channel ID and the connection ID (802.16e CID).

Then, the ROHC downlink packet with the connection ID (CID) is transmitted toward the mobile station (S614a). At this time, the mobile station corresponds to the connection ID (CID).

When the mobile station receives the ROHC downlink packet (S616a), the mobile station performs the classification procedure to determine whether or not the ROHC should be applied (S618a). At this time, if there is the ROHC channel ID mapped to the corresponding service flow, the mobile station classifies the corresponding ROHC downlink packet as one requiring the ROHC, through the use of mapping information of the ROHC channel ID and the service flow.

If it is determined that the ROHC should be applied, the ROHC de-compressor in the mobile station reconstructs the header of ROHC downlink packet by de-compressing the ROHC downlink packet through the ROHC context ID pre-stored therein (S620a). Then, the IP version of downlink packet with the reconstructed headers and downlink packet which doesn't require the ROHC is classified (S622a), and then the classified downlink packet is transmitted to the upper layer (S624a).

FIG. 6B is a block diagram illustrating the ROHC uplink packet processing method when the base station and the mobile station include the ROHC compressor and ROHC de-compressor.

First, when the mobile station obtains the uplink packet (S602b), the upper layer of the mobile station transmits the uplink packet to the IP layer, to thereby classify the IP of the uplink packet (S604b).

Before transmitting the uplink packet to an MAC layer, the procedure for determining whether or not the ROHC should be applied is performed (S606b). In this case, a classification rule can be implemented within a shim layer between the IP layer and a ROHC layer, or within the ROHC layer.

If the corresponding uplink packet is classified as one requiring the ROHC, the ROHC compressor of the mobile station compresses the uplink packet, and generates the ROHC uplink packet with the ROHC context ID mapped to the IP flow of the uplink packet (S608b).

In order to transmit the ROHC uplink packet to the base station, the connection ID (CID) is determined (S610b). At this time, the connection ID (CID) is determined by the mapping table of the ROHC channel ID and the connection ID (CID). Then, the ROHC uplink packet is transmitted to the base station corresponding to the connection ID (S612b).

When the base station receives the ROHC uplink packet (S614b), the classification procedure for determining whether or not the received ROHC uplink packet should be applied by ROHC is performed (S616b). At this time, when the DPF of the base station receives the ROHC uplink packet from the mobile station, the DPF finds an SFID, and determines whether or not the SFID is mapped to the ROHC channel. If there is the ROHC channel mapped to the SFID, the DPF of the base station determines that the ROHC should be applied.

If it is determined that the ROHC should be applied, the ROHC de-compressor of the base station reconstructs the header of the uplink packet by de-compressing the ROHC uplink packet through the ROHC context ID pre-stored (S618b).

The base station performs the classification procedure to determine the ASN-GW and the data path tag by the SFID (S620b). At this time, the base station determines the data path tag pre-stored and mapped to the connection ID (CID) Also, the base station determines the ASN-GW mapped to the data path tag selected.

Then, the base station transmits the uplink packet with the data path tags such as GRE key to an anchor ASN-GW through R6 data path (S622b). When the ASN-GW receives the uplink packet (S624b), the ASN-GW transmits the uplink packet to the CSN (S626b).

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A header-compression packet processing method in a wireless communication system comprising:
when a service flow of a downlink packet is mapped to a header-compression transmission channel, obtaining a second packet by adding a header-compression context ID mapped to an IP flow of the downlink packet to a first packet made by compressing a header of the downlink packet, in a control station;
adding a data path tag mapped to the service flow of the downlink packet to the second packet; and
transmitting the second packet with the data path tag to a base station maintaining mapping information of a connection ID for a corresponding mobile station and the data path tag, so as to transmit the second packet with the data path tag to the corresponding mobile station using the header-compression transmission channel.

2. The header-compression packet processing method according to claim 1, further comprising performing a header-compression parameter negotiation with the corresponding mobile station, so as to create the header-compression transmission channel in the corresponding mobile station.

3. The header-compression packet processing method according to claim 2, wherein the header-compression parameter negotiation is performed through the use of service flow information of the downlink packet including the header-compression context ID and a classifier to identify whether or not ROHC should be applied.

4. The header-compression packet processing method according to claim 1, wherein the data path tag mapped to the service flow is determined by a service flow ID of the service flow and a channel ID of the header-compression transmission channel.

5. The header-compression packet processing method according to claim 1, wherein a procedure for generating the first packet is performed by a ROHC method.

6. The header-compression packet processing method according to claim 1, wherein the header-compression context ID has ‘N’ types, and a mapping relationship between the service flow and the header-compression context ID is 1:N.

7. The header-compression packet processing method according to claim 1, wherein the data path tag corresponds to a data path ID included in the service flow information of the service flow.

8. The header-compression packet processing method according to claim 7, wherein the data path ID is a GRE key.

9. A header-compression packet processing method in a wireless communication system comprising:
receiving a second packet with a data path tag mapped to a connection ID of an uplink packet in a control station from a base station which receives the second packet obtained by adding a header-compression context ID mapped to an IP flow of the uplink packet to a first packet made by compressing a header of the uplink packet; and
when a service flow corresponding to the data path tag of the second packet is mapped to a header-compression transmission channel including a header-compression transmission ID, reconstructing the header of the uplink packet by decompressing the second packet through the header-compression context ID.

10. The header-compression packet processing method according to claim 9, further comprising performing a header-compression parameter negotiation with a mobile station, so as to generate the header-compression transmission channel with the header-compression context ID in the mobile station.

11. The header-compression packet processing method according to claim 10, wherein the header-compression parameter negotiation is performed through the use of service flow information of the uplink packet including the header-compression context ID and a classifier to identify whether or not a header-compression method should be applied.

12. The header-compression packet processing method according to claim 9, wherein the service flow mapped to the header-compression transmission channel including the header-compression transmission ID is determined according to a service flow ID of the service flow and a channel ID of the header-compression transmission channel.

13. The header-compression packet processing method according to claim 9, wherein a procedure for generating the first packet is performed by a ROHC method.

14. The header-compression packet processing method according to claim 9, wherein the header-compression context ID has ‘N’ types, and a mapping relationship between the service flow and the header-compression context ID is 1:N.

15. The header-compression packet processing method according to claim 9, wherein the data path tag corresponds to a data path ID included in the service flow information of the service flow.

16. The header-compression packet processing method according to claim 15, wherein the data path ID is a GRE key.

17. A header-compression packet processing method in a wireless communication system comprising:
receiving a downlink packet with a data path tag mapped to a service flow of a downlink packet in a base station from a control station, in a base station;
when the service flow of the downlink packet is mapped to a header-compression transmission channel, obtaining a second packet by adding a header-compression context ID mapped to an IP flow of the downlink packet to a first packet made by compressing a header of the downlink packet; and
transmitting the second packet to a mobile station corresponding to a connection ID mapped to the data path tag, so as to transmit the second packet to the mobile station using the header-compression transmission channel.

18. The header-compression packet processing method according to claim 17, further comprising performing a header-compression parameter negotiation with the mobile station, so as to generate the header-compression transmission channel in the mobile station.

19. The header-compression packet processing method according to claim 18, wherein the header-compression parameter negotiation is performed through the use of service flow information of the downlink packet including the header-compression context ID and a classifier to identify whether or not a header-compression method should be applied.

20. A header-compression packet processing method in a wireless communication system comprising:
receiving a second packet, obtained by adding a header-compression context ID mapped to an IP flow of an uplink packet to a first packet made by compressing a header of the uplink packet, in a base station from a mobile station;
when a service flow corresponding to a connection ID of the second packet is mapped to a header-compression transmission channel including the header-compression context ID, reconstructing the header of the uplink packet by decompressing the second packet through the header-compression context ID; and
adding a data path tag mapped to the connection ID to the uplink packet with the reconstructed header, and transmitting it to the base station mapped to the data path tag.

21. The header-compression packet processing method according to claim 20, further comprising performing a header-compression parameter negotiation with the mobile station, so as to generate the header-compression transmission channel including the header-compression context ID in the mobile station.

22. The header-compression packet processing method according to claim 21, wherein the header-compression parameter negotiation is performed through the use of service flow information of the uplink packet including the header-compression context ID and a classifier to identify whether or not a header-compression method should be applied.

23. A header-compression packet processing method in a wireless communication system comprising:
performing a ROHC compression for a data packet so as to map a service flow of the data packet and a ROHC channel by 1:1 correspondence; and
transmitting the ROHC-compressed data packet with a data path ID mapped to the service flow.

24. The header-compression packet processing method according to claim 23, wherein one ROHC channel includes a plurality of ROHC contexts.

25. The header-compression packet processing method according to claim 23, wherein the data path ID is a GRE key.

26. A header-compression packet processing method in a wireless communication system comprising:
performing a ROHC compression for a data packet so as to map a service flow of the data packet and a ROHC channel by 1:1 correspondence; and
transmitting the ROHC-compressed data packet with a connection ID mapped to the service flow.

27. The header-compression packet processing method according to claim 26, wherein the connection ID corresponds to a connection ID defined in IEEE 802.16e standards.

28. A control station in a wireless communication system comprising:
a header compressor configured to generate a second packet by adding a first header context ID mapped to an IP flow of a downlink packet to a first packet obtained by compressing a header of downlink packet;
a header de-compressor configured to reconstruct a header of uplink packet by decompressing a second uplink packet through a second header-compression context ID when a fourth packet with the second header-compression context ID mapped to an IP flow of uplink packet is transmitted to a third packet obtained by compressing the header of uplink packet; and
a data path function configured to transmit the second packet with a data path tag mapped to a service flow of the downlink packet to a base station mapped to the data path tag, and to transmit the fourth packet to the header de-compressor when a header-compression transmission channel including the second header-compression context ID is mapped to the service flow of the uplink packet.

29. The control station according to claim 28, wherein the header compressor and header de-compressor negotiate header-compression parameters with a mobile station through service flow information of the downlink packet including the first header-compression context ID and information related whether or not a header-compression method should be applied to the downlink packet.

30. The control station according to claim 29, wherein the service flow information of the downlink packet includes a packet classification rule including the first header-compression context ID as a sub-TLV.

31. The control station according to claim 28, wherein the header compressor uses a ROHC method.

32. The control station according to claim 28, wherein the first header-compression context ID has ‘N’ types, and a mapping relationship between the service flow of the downlink packet and the first header-compression context ID is 1:N.

33. The control station according to claim 28, wherein the data path tag is a data path ID included in the service flow information of the downlink packet.

34. A base station in a wireless communication system comprising:
a header compressor configured to generate a second packet by adding a first header-compression context ID mapped to an IP flow of downlink packet to a first packet obtained by compressing a header of downlink packet;
a header de-compressor configured to reconstruct a header of uplink packet by decompressing a fourth packet through a second header-compression context ID when the fourth packet with the second header-compression context ID mapped to an IP flow of uplink packet is transmitted to a third packet obtained by compressing the header of uplink packet; and
a data path function configured to transmit the second packet to a mobile station according to a connection ID mapped to a data path tag added to the downlink packet and transmitted from a control station, and to transmit the fourth packet to the header de-compressor when a header-compression transmission channel including the second header-compression context ID is mapped to a service flow of the uplink packet.

35. The base station according to claim 34, wherein the header compressor uses a ROHC method.

36. The base station according to claim 34, wherein the first header-compression context has ‘N’ types, and a mapping relationship between the service flow of the downlink packet and the first header-compression context ID is 1:N.

37. A mobile station in a wireless communication system comprising:
a header compressor configured to generate a second packet by adding a first header-compression context ID mapped to an IP flow of uplink packet to a first packet obtained by compressing a header of uplink packet;
a header de-compressor configured to reconstruct a header of downlink packet by decompressing a fourth packet through a second header-compression context ID when the fourth packet with the second header-compression context ID mapped to an IP flow of downlink packet is transmitted to a third packet obtained by compressing the header of downlink packet; and
a data path function configured to transmit the second packet to a base station mapped to a connection ID corresponding to a service flow of the uplink packet, and to transmit the fourth packet to the header-compressor when a header-compression transmission channel is mapped to the connection ID of the downlink packet.

38. The mobile station according to claim 37, wherein the header compressor uses a ROHC method.

39. The mobile station according to claim 37, wherein the first header-compression context ID has ‘N’ types, and a mapping relationship between the service flow of the downlink packet and the first header-compression context ID is 1:N.
